(19) United States
(12) Patent Application Publication
(10) Pub. No.: US 2025/0179338 A1
(43) Pub. Date: Jun. 5, 2025

(54) TWO-COMPONENT POLYURETHANE ADHESIVE

(71) Applicants: DuPont Technology (Shanghai) Co., Ltd., Shanghai (CN); DUPONT CHINA HOLDING COMPANY LTD, Shenzhen, Guangdong (CN)

(72) Inventors: Yiqing HU, Shanghai (CN); Jinyong WANG, Shanghai (CN)

(21) Appl. No.: 18/843,967

(22) PCT Filed: Mar. 25, 2022
(86) PCT No.: PCT/CN2022/083075

§ 371 Date: Sep. 4, 2024

(51) Int. Cl. C09J 175/12; C08G 18/12; C08G 18/32; C08G 18/48; C08G 18/66; C08K 3/22; C08K 5/3492; C09J 9/00; C09J 11/04; C09J 11/06; C09K 5/14

(52) U.S. Cl. CPC C09J 175/12; C08G 18/12; C08G 18/3206; C08G 18/4829; C08G 18/4841; C08G 18/6674; C09J 9/00; C09J 11/04; C09J 11/06; C09K 5/14; C08K 2003/2227; C08K 5/34928; C08K 2201/005

(57) ABSTRACT

Provided herein is a two-component flame-retardant polyurethane adhesive.

### FIELD OF INVENTION

The present invention relates to the field of adhesives, in particular two-component polyurethane adhesives.

### BACKGROUND OF THE INVENTION

The use of aluminium alloy in the building blocks for car body design is growing due to the continuous drive for weight reduction. In particular for electrical vehicles (EV), where the battery brings extra weight to the entire vehicle. The battery itself uses a lot aluminium alloy for the various structures and components. For example the housing of the battery pack is typically made from aluminium, and the side and edge panels of battery modules are made of aluminium alloy as well. The joining of aluminium alloy to other components for the battery becomes critical. Adhesive bonding is the current popular joining method for aluminium in the automotive industry together with other joining methods such as welding, and riveting. The typical bonding strength needed for bonding structural components should be higher than 5 MPa, or preferably higher than 10 MPa.

The most commonly used adhesive to bond aluminium alloy is based on epoxy and acrylic chemistry. However, epoxy adhesives have a relatively slow curing speed, and they can be brittle in the cured state. This hinders the application of epoxy adhesives for structural bonding of aluminium alloy inside battery pack applications. Acrylic based adhesives often have an unpleasant smell, making them not very user friendly.

Polyurethane (PU) adhesives are typically used for bonding painted substrates and plastic components in automotive applications. However, PU adhesives do not typically provide strong, durable bonding to aluminium alloy, in particular, adhesion to aluminium decreases significantly when exposed to harsh weathering conditions such as high temperature and high humidity. In addition, for battery applications, the adhesive used inside of battery pack should be fire- or flame-resistant. Flame retardant additives typically used in polyurethane industry are halogen-containing or phosphorus-based.

Unfortunately, these additives often lead to a dramatic reduction of adhesion or bonding performance of the adhesive, thereby detracting from the structural properties of the bonding system.

### SUMMARY OF THE INVENTION

In a first aspect, the invention provides a two-component thermally conductive polyurethane adhesive formulation comprising:
(A) a first part, comprising:
(a1) a polyurethane prepolymer made from at least one polyol, at least one polyisocyanate and an aminosilane, wherein the prepolymer is partially terminated with silane moieties and has reactive NCO moieties;
(B) a second part, comprising:
(b1) one or more polyether polyols;
(b2) one or more catalysts capable of promoting the reaction of the NCO moieties of (a1) with (b1);
wherein Part A and/or Part B comprise aluminium hydroxide having a D₅₀ of less than 5 microns, and melamine polyphosphate, such that when Part A and Part B are mixed together to form an adhesive mixture (preferably in a 1:1 volumetric ratio), the aluminium hydroxide concentration is at least 20 wt % percent, and the melamine polyphosphate concentration is at least 7 wt %.

A method for adhering two or more substrates, comprising the steps:
(1) providing a two-component thermally conductive polyurethane adhesive formulation comprising:
   (A) a first part, comprising:
   (a1) a polyurethane prepolymer made from at least one polyol, at least one polyisocyanate and an aminosilane, wherein the prepolymer is partially terminated with silane moieties and has reactive NCO moieties;
   (B) a second part, comprising:
   (b1) one or more polyether polyols;
   (b2) one or more catalysts capable of promoting the reaction of the NCO moieties of (a1) with (b1);
   wherein Part A and/or Part B comprise aluminium hydroxide having a D₅₀ of less than 5 microns, and melamine polyphosphate, such that when Part A and Part B are mixed together to form an adhesive mixture, the aluminium hydroxide concentration is at least 20 wt % percent, and the melamine polyphosphate concentration is at least 7 wt %;
(2) mixing Part A and Part B to provide an uncured adhesive;
(3) applying the uncured adhesive to at least one substrate;
(4) bringing the uncured adhesive into adhesive contact with a second substrate;
(5) allowing the uncured adhesive to cure.

An adhered assembly, comprising:
(1) a first substrate;
(2) a second substrate;
wherein the first and second substrate are adhered one to the other by a cured adhesive resulting from mixing together the following Parts A and B:
   (A) a first part, comprising:
   (a1) a polyurethane prepolymer made from at least one polyol, at least one polyisocyanate and an aminosilane, wherein the prepolymer is partially terminated with silane moieties and has reactive NCO moieties;
   (B) a second part, comprising:
   (b1) one or more polyether polyols;
   (b2) one or more catalysts capable of promoting the reaction of the NCO moieties of (a1) with (b1);
   wherein Part A and/or Part B comprise aluminium hydroxide having a D₅₀ of less than 5 microns, and melamine polyphosphate, such that when Part A and Part B are mixed together to form an adhesive mixture, the aluminium hydroxide concentration is at least 20 wt % percent, and the melamine polyphosphate concentration is at least 7 wt %, and allowing the mixture to cure.

### DETAILED DESCRIPTION OF THE INVENTION

The inventors have found that flame-retardant adhesives can be formulated with polyurethanes to offer i) lap shear strengths on aluminium of >8 MPa, ii) flame-retardancy ratings of V0, and iii) good retention of lap shear strength after prolonged exposure to harsh conditions.

### Definitions and Abbreviations

DSC Differential scanning calorimetry
MDI 4,4′-Methylenebis(phenyl isocyanate)
HDI Hexamethylene diisocyanate
IPDI isophorone diisocyanate
PU polyurethane
SEC size exclusion chromatography
RH relative humidity
ATH aluminium trihydroxide
MPP melamine polyphosphate

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

The adhesive of the invention is a two-component polyurethane adhesive, comprising an A Part and B Part. The A Part and the B Part may be packaged together as a kit. The A Part and the B Part are mixed together at an appropriate ratio, preferably 1:1 by volume, prior to use and then applied as soon as practicable to the substrate or substrates.

The A Part and the B Part will now be disclosed in more particular detail.

### A Part (Isocyanate)

Part A comprises a polyurethane prepolymer made from at least one polyol, at least one polyisocyanate and an aminosilane, wherein the prepolymer is partially terminated with silane moieties and has reactive NCO moieties.

The polyisocyanate used to make the prepolymer may be aliphatic, aromatic, or a mixture, with aromatic polyisocyanates being preferred. Examples of aromatic polyisocyanates include methylene diphenyl diisocyanate (MDI), polycarbodiimide-modified MDI, toluene diisocyanate (TDI), p-phenylene diisocyanate (PPDI), and naphthalene diisocyanate (NDI). MDI is particularly preferred and/or polycarbodiimide-modified MDI. In some embodiments, a mixture of MDI and polycarbodiimide-modified MDI is used.

The polyisocyanate used to make the prepolymer is preferably used at 35-65 wt %, more preferably 40-60 wt %, particularly preferably 45-55 wt %, based on the total weight of Component A.

In a particularly preferred embodiment, the prepolymer is made using MDI and/or polycarbodiimide-modified MDI at 35-65 wt %, more preferably 40-60 wt %, particularly preferably 45-55 wt %, based on the total weight of Component A.

The polyol used to make the prepolymer is preferably a polyether polyol. The polyol may have two or more OH groups. Examples of polyether polyols include poly(alkylene oxide)diols, wherein the alkylene group is C₂-C₆, particularly preferably the alkylene group is C₂-C₄. Examples of suitable polyols include poly(ethylene oxide)polyols, poly(propylene oxide)polyols, poly(tetramethylene oxide)polyols. Particularly preferred are poly(propylene oxide)polyols, particularly poly(propylene glycol). In a preferred embodiment, the polyether polyol is a polyether polyol based on propylene glycol. In a particularly preferred embodiment, it is a polyether polyol based on propylene glycol with ethylene oxide capping, having a molecular weight of approximately 2,000 Da, a functionality of 2.

The polyether polyol used to make the prepolymer is preferably used at 5 to 20 wt %, more preferably 8 to 15 wt %, particularly preferably at 9 to 12 wt %, based on the total weight of Component A.

In a preferred embodiment, the polyol used to make the prepolymer is a polyether polyol based on propylene glycol, used at 5 to 20 wt %, more preferably 8 to 15 wt %, particularly preferably at 9 to 12 wt %, based on the total weight of Component A.

The polyisocyanate is used in excess to the polyether polyol such that the prepolymer is terminated with isocyanate groups. The final prepolymer preferably has an NCO wt % in the range of 5-30 wt %, more preferably in the range of 10-25 wt %.

The aminosilane in Component A is preferably of general Formula I or Formula II:

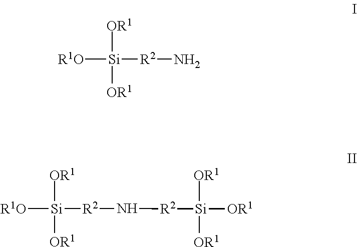

where R¹ is independently selected from C₁-C₆ alkyl, and R² is independently selected from C₂-C₆ alkylene.

In a preferred embodiment, the aminosilane in Component A is of general Formula I, R¹ is C₁-C₂ alkyl, and R₂ is C₂-C₄ alkylene. In a more preferred embodiment, the aminosilane is of general Formula I, R¹ is methyl, and R₂ is propylene.

In another preferred embodiment, the aminosilane in Component A is of general Formula II, R¹ is C₁-C₂ alkyl, and R₂ is C₂-C₄ alkylene. In a more preferred embodiment, the aminosilane is of general Formula II, R¹ is methyl, and R₂ is propylene.

In a particularly preferred embodiment, the aminosilane in Component A is bis-(trimethoxysilylpropyl)amine.

The aminosilane in Component A is preferably used at 0.5-4 wt %, more preferably 1-3 wt %, particularly preferably 1.5-2.5 wt %, based on the total weight of Component A.

In a preferred embodiment, the amino silane in Component A is bis-(trimethoxysilylpropyl)amine, used at 0.5-4 wt %, more preferably 1-3 wt %, particularly preferably 1.5-2.5 wt %, based on the total weight of Component A.

In a preferred embodiment, the prepolymer in Component A is made using:
polyisocyanate at 35-65 wt %, more preferably 40-60 wt %, particularly preferably 45-55 wt %, based on the total weight of Component A;
polyether polyol at 5 to 20 wt %, more preferably 8 to 15 wt %, particularly preferably at 9 to 12 wt %, based on the total weight of Component A; and
aminosilane at 0.5-4 wt %, more preferably 1-3 wt %, particularly preferably 1.5-2.5 wt %, based on the total weight of Component A.

In a more preferred embodiment, the prepolymer in Component A is made using:
MDI and/or polycarbodiimide-modified MDI, or a mixture of MDI and polycarbodiimide-modified MDI at 35-65 wt %, more preferably 40-60 wt %, particularly preferably 45-55 wt %, based on the total weight of Component A;
polyether polyol based on propylene glycol, preferably a polyether polyol based on propylene glycol having an OH value (mg KOH/g) of 109-115 at 5 to 20 wt %, more preferably 8 to 15 wt %, particularly preferably at 9 to 12 wt %, based on the total weight of Component A; and
aminosilane of general Formula II, wherein R¹ is C₁-C₂ alkyl, and R₂ is C₂-C₄ alkylene, more preferably R¹ is methyl, and R₂ is propylene at 0.5-4 wt %, more preferably 1-3 wt %, particularly preferably 1.5-2.5 wt %, based on the total weight of Component A.

In a particularly preferred embodiment, the prepolymer in Component A is made using:
a mixture of MDI and polycarbodiimide-modified MDI at 45-55 wt %, based on the total weight of Component A;
a polyether polyol based on propylene glycol having an OH value (mg KOH/g) of 109-115 at 9 to 12 wt %, based on the total weight of Component A; and
bis-(trimethoxysilylpropyl)amine at 0.5-4 wt %, more preferably 1-3 wt %, particularly preferably 1.5-2.5 wt %, based on the total weight of Component A.

The prepolymer is made by mixing the components, preferably under dry and/or inert atmosphere, for a period of time sufficient to result in reaction of substantially all of the polyol OH groups and the aminosilane amino groups with the polyisocyanate. In a preferred embodiment, mixing is carried out for 1 to 2 hours. The proportions are chosen so that the prepolymer is terminated with isocyanate groups and partially silane groups.

Part B (polyol)

Part B comprises:
one or more polyether polyols; and
one or more catalysts capable of promoting the reaction of the NCO moieties of the prepolymer with the polyol of Component B.

The polyol used in Component B is a polyether polyol. The polyol may have two or more OH groups. Examples of polyether polyols include poly(alkylene oxide)diols, wherein the alkylene group is C₂-C₆, particularly preferably the alkylene group is C₂-C₄. Examples of suitable polyols include poly(ethylene oxide)polyols, poly(propylene oxide)polyols, poly(tetramethylene oxide)polyols. Particularly preferred are poly(propylene oxide)polyols.

In a preferred embodiment, the polyether polyol of Component B is a mixture of polyols having functionalities of 2-6. In a particularly preferred embodiment, the polyether polyol of Component B is a mixture of at least one diol, at least one triol and at least one polyol of functionality >3.

In a preferred embodiment, the polyether polyol of Component B is a mixture comprising or consisting of a diol, a triol, and a polyol having nominal functionality of 5-6.

In a preferred embodiment, the polyether polyol of Component B is a mixture of poly(propylene oxide) polyols having functionalities of 2-6. In a particularly preferred embodiment, the polyether polyol of Component B is a mixture comprising or consisting of at least one poly(propylene oxide) diol, at least one poly(propylene oxide) triol and at least one poly(propylene oxide) polyol of functionality >3.

In a preferred embodiment, the polyether polyol of Component B is a mixture comprising or consisting of a poly(propylene oxide) diol, a poly(propylene oxide) triol and a poly(propylene oxide) polyol having nominal functionality of 5-6.

In another preferred embodiment, the polyether polyol of Component B comprises 46-83 wt % of a polyether triol, 19-46 wt % of a polyether polyol having functionality >3, 4-15 wt % of a polyether diol, based on the total weight of polyether polyol in Component B.

In another preferred embodiment, the polyether polyol of Component B comprises 55-65 wt % of a polyether triol, 25-35 wt % of a polyether polyol having functionality >3, 5-8 wt % of a polyether diol, based on the total weight of polyether polyol in Component B.

In another preferred embodiment, the polyether polyol of Component B comprises 46-83 wt % of a poly(propylene oxide) triol, 19-46 wt % of a poly(propylene oxide) polyol having functionality >3, 4-15 wt % of a poly(propylene oxide) diol, based on the total weight of polyether polyol in Component B.

In another preferred embodiment, the polyether polyol of Component B comprises 55-65 wt % of a poly(propylene oxide) triol, 25-35 wt % of a poly(propylene oxide) polyol having functionality >3, 5-8 wt % of a poly(propylene oxide) diol, based on the total weight of polyether polyol in Component B.

The total polyether polyol in Component B is preferably present at 35 to 70 wt %, more preferably 40 to 60 wt %, particularly preferably 50 to 57 wt %, based on the total weight of Component B.

In a preferred embodiment, Component B comprises 35 to 70 wt %, more preferably 40 to 60 wt %, particularly preferably 50 to 57 wt %, based on the total weight of Component B, of a mixture of polyether polyols comprising or consisting of:
(1) 46-83 wt % of a polyether triol, 19-46 wt % of a polyether polyol having functionality >3, 4-15 wt % of a polyether diol, based on the total weight of polyether polyol in Component B; or
(2) 55-65 wt % of a polyether triol, 25-35 wt % of a polyether polyol having functionality >3, 5-8 wt % of a polyether diol, based on the total weight of polyether polyol in Component B; or
(3) 46-83 wt % of a poly(propylene oxide) triol, 19-46 wt % of a poly(propylene oxide) polyol having functionality >3, 4-15 wt % of a poly(propylene oxide) diol, based on the total weight of polyether polyol in Component B; or
(4) 55-65 wt % of a poly(propylene oxide) triol, 25-35 wt % of a poly(propylene oxide) polyol having functionality >3, 5-8 wt % of a poly(propylene oxide) diol, based on the total weight of polyether polyol in Component B.

Component B may optionally comprise a diol of molecular weight <200 Da, more preferably <150 Da. Examples include propylene glycol and butane diol, with butane diol (e.g. 1,4-butane diol) being particularly preferred.

If present, the diol of molecular weight <200 Da is preferably used at 5 to 12 wt %, more preferably 6-10 wt %, particularly preferably 8-9 wt %, based on the total weight of Component B.

In a preferred embodiment, Component B comprises butane diol (e.g. 1,4-butane diol) at 5 to 12 wt %, more preferably 6-10 wt %, particularly preferably 8-9 wt %, based on the total weight of Component B.

Component B comprises one or more catalysts capable of promoting the reaction of the NCO moieties of the prepolymer of Component A with the one or more polyether polyols of Component B.

The catalyst is preferably selected from Lewis bases and Lewis acids.

Preferred are tertiary amines, including diazabicyclo[2.2.2]octane, tris-2,4,6-((dimethylamino)methyl)phenol, DMDEE (2,2′-Dimorpholinodiethylether), imidazoles, such as 4-methylimidazole), triethanolamine, polyethyleneimine, with diazabicyclo[2.2.2]octane being particularly preferred.

Also suitable are organotin compounds, such as dioctyltindineodecanoate, dibutyltin di(acetate), and di-n-octyltin bis(isooctyl mercaptoacetate). With dibutyltin di(acetate) being particularly preferred.

In a preferred embodiment, the catalyst comprises diazabicyclo[2.2.2]octane and dibutyltin di(acetate).

The catalyst is preferably used at 0.05-0.5 wt %, more preferably 0.1-0.3 wt %, particularly preferably 0.2 wt %, based on the total weight of Component B.

In a preferred embodiment, the catalyst is a mixture of diazabicyclo[2.2.2]octane and dibutyltin di(acetate), used at 0.05-0.5 wt %, more preferably 0.1-0.3 wt %, particularly preferably 0.2 wt %, based on the total weight of Component B.

### Aluminium Hydroxide and Melamine Polyphosphate

Part A and/or Part B comprise aluminium hydroxide having a D₅₀ of less than 5 microns, and melamine polyphosphate, such that when Part A and Part B are mixed together to form an adhesive mixture (preferably in a 1:1 volumetric ratio), the aluminium hydroxide concentration is at least 20 wt %, and the melamine polyphosphate concentration is at least 7 wt %, both based on the total weight of the mixture. Particle sizes and distributions being measured by light scattering using acetone as suspending medium.

Preferably the aluminium hydroxide concentration in the adhesive mixture is 20-35 wt %, more preferably at 22-26 wt %, based on the total weight of the mixture.

In a preferred embodiment, the aluminium hydroxide is present in Component A at 20-35 wt %, more preferably at 22-26 wt %, based on the total weight of Component A.

In another preferred embodiment, the aluminium hydroxide is present in Component B at 20-35 wt %, more preferably at 22-26 wt %, based on the total weight of Component B.

In a preferred embodiment, the aluminium hydroxide is present in both Component A and Component B.

In another preferred embodiment, the aluminium hydroxide is present in both Component A and Component B at 20-35 wt %, more preferably at 22-26 wt %, based on the total weight of the respective Component.

In a preferred embodiment, the aluminium hydroxide has a D₅₀ of less than 3 microns, more preferably about 1 micron.

Preferably the adhesive mixture resulting from mixing Components A and B (preferably in a 1:1 volumetric ratio) comprises aluminium hydroxide having a D₅₀ of less than 3 microns, more preferably about 1 micron, at 20-35 wt %, more preferably at 22-26 wt %, based on the total weight of the mixture.

In a preferred embodiment, Component A comprises aluminium hydroxide having a D₅₀ of less than 3 microns, more preferably about 1 micron, at 20-35 wt %, more preferably at 22-26 wt %, based on the total weight of Component A.

In another preferred embodiment, Component B comprises aluminium hydroxide having a D₅₀ of less than 3 microns, more preferably about 1 micron, at 20-35 wt %, more preferably at 22-26 wt %, based on the total weight of Component B.

In another preferred embodiment, both Component A and Component B comprise aluminium hydroxide having a D₅₀ of less than 3 microns, more preferably about 1 micron, at 20-35 wt %, more preferably at 22-26 wt %, based on the total weight of the respective Component.

Preferably the melamine polyphosphate concentration in the adhesive mixture is 7-15 wt %, more preferably 8-12 wt %, particularly preferably 9-11 wt %, based on the total weight of the mixture.

In a preferred embodiment, melamine polyphosphate is present in Component A at 7-15 wt %, more preferably at 8-12 wt %, based on the total weight of Component A.

In another preferred embodiment, melamine polyphosphate is present in Component B at 7-15 wt %, more preferably at 8-12 wt %, based on the total weight of Component B.

In a preferred embodiment, melamine polyphosphate is present in both Component A and Component B.

In another preferred embodiment, melamine polyphosphate is present in both Component A and Component B at 7-15 wt %, more preferably at 8-12 wt %, based on the total weight of the respective Component.

### Optional Ingredients in Components A and B

Components A and/or B may additionally comprise other ingredients, for example, talc, molecular sieves, silica (particularly amorphous silica), carbon black.

### Application to Substrate

Parts (A) and (B) are mixed and can be applied to a substrate using known methods, such as a manual application system or in an automated way with a pump system using 20 I pails or 200 I drums or any other preferred container.

Preferred substrates include aluminium, e-coated aluminium, e-coated steel, laser treated aluminium, or passivated aluminium.

### Characteristics

The cured adhesive composition resulting from mixing Components A and B preferably has a lap shear strength, on aluminium substrates, after curing and resting for 7 days at 23° C., 50% relative humidity, of 8 MPa or greater, more preferably 9 MPa or greater, particularly preferably 10 MPa or greater, when measured according to the method given in the Examples.

The cured adhesive composition resulting from mixing Components A and B preferably has a lap shear strength, on aluminium substrates, after curing and resting for 7 days at 23° C., 50% relative humidity, followed by 7 days of Cataplasma treatment of 6 MPa or greater, more preferably 9 MPa or greater, particularly preferably 10 MPA or greater, when measured according to the method given in the Examples.

The cured adhesive composition resulting from mixing Components A and B preferably has a lap shear strength, on aluminium substrates, after curing and resting for 7 days at 23° C., 50% relative humidity, followed by 168 hours at 85° C. and 85% relative humidity of 8 MPa or greater, more preferably 10 MPa or greater, particularly preferably 11 MPA or greater, when measured according to the method given in the Examples.

The cured adhesive composition resulting from mixing Components A and B preferably has a lap shear strength, on aluminium substrates, after curing and resting for 7 days at 23° C., 50% relative humidity, followed by 1,000 hours at 85° C. and 85% relative humidity of 8 MPa or greater, more preferably 10 MPa or greater, particularly preferably 11 MPA or greater, when measured according to the method given in the Examples.

The cured adhesive composition resulting from mixing Components A and B preferably has a UL94 rating of V0, after curing for 7 days at 23° C. and 50% relative humidity.

In a preferred embodiment, The cured adhesive composition resulting from mixing Components A and B (7 days at 23° C. and 50% relative humidity) has a lap shear strength, on aluminium substrates, after curing and resting for 7 days at 23° C., 50% relative humidity, of 8 MPa or greater, more preferably 9 MPa or greater, particularly preferably 10 MPa or greater, when measured according to the method given in the Examples, and a UL94 rating of V0, after curing for 7 days at 23° C. and 50% relative humidity.

In another preferred embodiment, the cured adhesive (7 days at 23° C. and 50% relative humidity) has a lap shear strength, on aluminium substrates, after 7 days of Cataplasma treatment of 6 MPa or greater, more preferably 9 MPa or greater, particularly preferably 10 MPA or greater, when measured according to the method given in the Examples, and a UL94 rating of V0, after curing for 7 days at 23° C. and 50% relative humidity.

In another preferred embodiment, the cured adhesive (7 days at 23° C. and 50% relative humidity) has a lap shear strength, on aluminium substrates, after 168 hours at 85° C. and 85% relative humidity, of 8 MPa or greater, more preferably 10 MPa or greater, particularly preferably 11 MPA or greater, when measured according to the method given in the Examples, and a UL94 rating of V0, after curing for 7 days at 23° C. and 50% relative humidity.

In another preferred embodiment, The cured adhesive composition resulting from mixing Components A and B (7 days at 23° C. and 50% relative humidity) has a lap shear strength, on aluminium substrates, after 1,000 hours at 85° C. and 85% relative humidity of 8 MPa or greater, more preferably 10 MPa or greater, particularly preferably 11 MPA or greater, when measured according to the method given in the Examples, and a UL94 rating of V0, after curing for 7 days at 23° C. and 50% relative humidity.

### Particularly Preferred Embodiments

The following are particularly preferred embodiments of the invention:
1. A two-component thermally conductive polyurethane adhesive formulation comprising:
   (A) a first part, comprising:
      (a1) a polyurethane prepolymer made from at least one polyol, at least one polyisocyanate and an aminosilane, wherein the prepolymer is partially terminated with silane moieties and has reactive NCO moieties;
   (B) a second part, comprising:
      (b1) one or more polyether polyols;
      (b2) one or more catalysts capable of promoting the reaction of the NCO moieties of (a1) with (b1);
   wherein Part A and/or Part B comprise aluminium hydroxide having a D₅₀ of less than 5 microns, and melamine polyphosphate, such that when Part A and Part B are mixed together to form an adhesive mixture, the aluminium hydroxide concentration is at least 20 wt % percent, and the melamine polyphosphate concentration is at least 7 wt %.
2. A method for adhering two or more substrates, comprising the steps:
   (1) providing a two-component thermally conductive polyurethane adhesive formulation comprising:
      (A) a first part, comprising:
         (a1) a polyurethane prepolymer made from at least one polyol, at least one polyisocyanate and an aminosilane, wherein the prepolymer is partially terminated with silane moieties and has reactive NCO moieties;
      (B) a second part, comprising:
         (b1) one or more polyether polyols;
         (b2) one or more catalysts capable of promoting the reaction of the NCO moieties of (a1) with (b1);
   wherein Part A and/or Part B comprise aluminium hydroxide having a D₅₀ of less than 5 microns, and melamine polyphosphate, such that when Part A and Part B are mixed together to form an adhesive mixture, the aluminium hydroxide concentration is at least 20 wt % percent, and the melamine polyphosphate concentration is at least 7 wt %;
   (2) mixing Part A and Part B to provide an uncured adhesive;
   (3) applying the uncured adhesive to at least one substrate;
   (4) bringing the uncured adhesive into adhesive contact with a second substrate;
   (5) allowing the uncured adhesive to cure.
3. An adhered assembly, comprising:
   (1) a first substrate;
   (2) a second substrate;
   wherein the first and second substrate are adhered one to the other by a cured adhesive resulting from mixing together the following Parts A and B:
      (A) a first part, comprising:
         (a1) a polyurethane prepolymer made from at least one polyol, at least one polyisocyanate and an aminosilane, wherein the prepolymer is partially terminated with silane moieties and has reactive NCO moieties;
      (B) a second part, comprising:
         (b1) one or more polyether polyols;
         (b2) one or more catalysts capable of promoting the reaction of the NCO moieties of (a1) with (b1);
   wherein Part A and/or Part B comprise aluminium hydroxide having a D₅₀ of less than 5 microns, and melamine polyphosphate, such that when Part A and Part B are mixed together to form an adhesive mixture, the aluminium hydroxide concentration is at least 20 wt % percent, and the melamine polyphosphate concentration is at least 7 wt %, and allowing the mixture to cure.
4. Any one preceding embodiment, wherein the polyisocyanate used to make the prepolymer is aromatic.
5. Any one preceding embodiment, wherein the polyisocyanate used to make the prepolymer is selected from methylene diphenyl diisocyanate (MDI), polycarbodiimide-modified MDI, toluene diisocyanate (TDI), p-phenylene diisocyanate (PPDI), naphthalene diisocyanate (NDI), and mixtures of these.
6. Any one preceding embodiment, wherein the polyisocyanate used to make the prepolymer is selected from an MDI, polycarbodiimide-modified MDI, and mixtures of these.
7. Any one preceding embodiment, wherein the polyisocyanate used to make the prepolymer is used at 35-65 wt %, more preferably 40-60 wt %, particularly preferably 45-55 wt %, based on the total weight of Component A.
8. Any one preceding embodiment, wherein the prepolymer is made using MDI and/or polycarbodiimide-modified MDI at 35-65 wt %, more preferably 40-60 wt %, particularly preferably 45-55 wt %, based on the total weight of Component A.
9. Any one preceding embodiment, wherein the polyol used to make the prepolymer is a polyether polyol.
10. Any one preceding embodiment, wherein the polyol used to make the prepolymer has two or more OH groups.
11. Any one preceding embodiment, wherein the polyol used to make the prepolymer is selected from poly(alkylene oxide)diols, wherein the alkylene group is C₂-C₆, particularly preferably the alkylene group is C₂-C₄.
12. Any one preceding embodiment, wherein the polyol used to make the prepolymer is a poly(propylene oxide)polyol.
13. Any one preceding embodiment, wherein the polyol used to make the prepolymer is a polyether polyol based on propylene glycol with ethylene oxide capping, having a molecular weight of approximately 2,000 Da, a functionality of 2.
14. Any one preceding embodiment, wherein the polyol used to make the prepolymer is used at 5 to 20 wt %, more preferably 8 to 15 wt %, particularly preferably at 9 to 12 wt %, based on the total weight of Component A.
15. Any one preceding embodiment, wherein the polyol used to make the prepolymer is a polyether polyol based on propylene glycol, used at 5 to 20 wt %, more preferably 8 to 15 wt %, particularly preferably at 9 to 12 wt %, based on the total weight of Component A.
16. Any one preceding embodiment, wherein the polyisocyanate is used in excess to the polyether polyol such that the prepolymer is terminated with isocyanate groups.
17. Any one preceding embodiment, wherein the prepolymer is terminated with isocyanate groups with NCO wt % in the range of 5-30%, preferably in the range of 10-25%.
18. Any one preceding embodiment, wherein the aminosilane in Component A is preferably of general Formula I or Formula II:

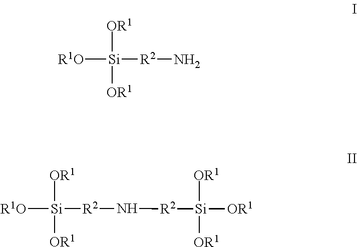

where R¹ is independently selected from C₁-C₆ alkyl, and R² is independently selected from C₂-C₆ alkylene.
19. Embodiment 18, wherein the aminosilane in Component A is of general Formula I, R¹ is C₁-C₂ alkyl, and R₂ is C₂-C₄ alkylene.
20. Embodiment 18, wherein the aminosilane is of general Formula I, R¹ is methyl, and R₂ is propylene.
21. Embodiment 18, wherein the aminosilane in Component A is of general Formula II, R¹ is C₁-C₂ alkyl, and R₂ is C₂-C₄ alkylene.
22. Embodiment 18, wherein the aminosilane is of general Formula II, R¹ is methyl, and R₂ is propylene.
23. Any one preceding embodiment, wherein the aminosilane in Component A is bis-(trimethoxysilylpropyl)amine.
24. Any one preceding embodiment, wherein the aminosilane in Component A is used at 0.5-4 wt %, more preferably 1-3 wt %, particularly preferably 1.5-2.5 wt %, based on the total weight of Component A.
25. Any one preceding embodiment, wherein the amino silane in Component A is bis-(trimethoxysilylpropyl)amine, used at 0.5-4 wt %, more preferably 1-3 wt %, particularly preferably 1.5-2.5 wt %, based on the total weight of Component A.
26. Any one preceding embodiment, wherein the prepolymer in Component A is made using:
   polyisocyanate at 35-65 wt %, more preferably 40-60 wt %, particularly preferably 45-55 wt %, based on the total weight of Component A;
   polyether polyol at 5 to 20 wt %, more preferably 8 to 15 wt %, particularly preferably at 9 to 12 wt %, based on the total weight of Component A; and
   aminosilane at 0.5-4 wt %, more preferably 1-3 wt %, particularly preferably 1.5-2.5 wt %, based on the total weight of Component A.
27. Any one preceding embodiment, wherein the prepolymer in Component A is made using:
   MDI and/or polycarbodiimide-modified MDI, or a mixture of MDI and polycarbodiimide-modified MDI at 35-65 wt %, more preferably 40-60 wt %, particularly preferably 45-55 wt %, based on the total weight of Component A;
   polyether polyol based on propylene glycol, preferably a polyether polyol based on propylene glycol having an OH value (mg KOH/g) of 109-115 at 5 to 20 wt %, more preferably 8 to 15 wt %, particularly preferably at 9 to 12 wt %, based on the total weight of Component A; and
   aminosilane of general Formula II, wherein R¹ is C₁-C₂ alkyl, and R₂ is C₂-C₄ alkylene, more preferably R¹ is methyl, and R₂ is propylene at 0.5-4 wt %, more preferably 1-3 wt %, particularly preferably 1.5-2.5 wt %, based on the total weight of Component A.
28. Any one preceding embodiment, wherein the prepolymer in Component A is made using:
   a mixture of MDI and polycarbodiimide-modified MDI at 45-55 wt %, based on the total weight of Component A;
   a polyether polyol based on propylene glycol having an OH value (mg KOH/g) of 109-115 at 9 to 12 wt %, based on the total weight of Component A; and
   bis-(trimethoxysilylpropyl)amine at 0.5-4 wt %, more preferably 1-3 wt %, particularly preferably 1.5-2.5 wt %, based on the total weight of Component A.
29. Any one preceding embodiment, wherein the polyether polyol used in Component B is selected from poly(alkylene oxide)diols, wherein the alkylene group is C₂-C₆, particularly preferably the alkylene group is C₂-C₄, and mixtures of these.
30. Any one preceding embodiment, wherein the polyether polyol used in Component B is selected from poly(propylene oxide)polyols, and mixtures of these.
31. Any one preceding embodiment, wherein the polyether polyol used in Component B is a mixture of polyols having functionalities of 2-6.
32. Any one preceding embodiment, wherein the polyether polyol used in Component B is a mixture of at least one diol, at least one triol and at least one polyol of functionality >3.
33. Any one preceding embodiment, wherein the polyether polyol used in Component B is a mixture comprising or consisting of a diol, a triol, and a polyol having nominal functionality of 5-6.
34. Any one preceding embodiment, wherein the polyether polyol used in Component B is a mixture of poly(propylene oxide) polyols having functionalities of 2-6.
35. Any one preceding embodiment, wherein the polyether polyol used in Component B is a mixture comprising or consisting of at least one poly(propylene oxide) diol, at least one poly(propylene oxide) triol and at least one poly(propylene oxide) polyol of functionality >3.
36. Any one preceding embodiment, wherein the polyether polyol used in Component B is a mixture comprising or consisting of a poly(propylene oxide) diol, a poly(propylene oxide) triol and a poly(propylene oxide) polyol having nominal functionality of 5-6.
37. Any one preceding embodiment, wherein the polyether polyol used in Component B comprises 46-83 wt % of a polyether triol, 19-46 wt % of a polyether polyol having functionality >3, 4-15 wt % of a polyether diol, based on the total weight of polyether polyol in Component B.
38. Any one preceding embodiment, wherein the polyether polyol used in Component B comprises 55-65 wt % of a polyether triol, 25-35 wt % of a polyether polyol having functionality >3, 5-8 wt % of a polyether diol, based on the total weight of polyether polyol in Component B.
39. Any one preceding embodiment, wherein the polyether polyol used in Component B comprises 46-83 wt % of a poly(propylene oxide) triol, 19-46 wt % of a poly(propylene oxide) polyol having functionality >3, 4-15 wt % of a poly(propylene oxide) diol, based on the total weight of polyether polyol in Component B.
40. Any one preceding embodiment, wherein the polyether polyol used in Component B comprises 55-65 wt % of a poly(propylene oxide) triol, 25-35 wt % of a poly(propylene oxide) polyol having functionality >3, 5-8 wt % of a poly(propylene oxide) diol, based on the total weight of polyether polyol in Component B.
41. Any one preceding embodiment, wherein the polyether polyol used in Component B is present at 35 to 70 wt %, more preferably 40 to 60 wt %, particularly preferably 50 to 57 wt %, based on the total weight of Component B.
42. Any one preceding embodiment, wherein Component B comprises 35 to 70 wt %, more preferably 40 to 60 wt %, particularly preferably 50 to 57 wt %, based on the total weight of Component B, of a mixture of polyether polyols comprising or consisting of:
   (1) 46-83 wt % of a polyether triol, 19-46 wt % of a polyether polyol having functionality >3, 4-15 wt % of a polyether diol, based on the total weight of polyether polyol in Component B; or
   (2) 55-65 wt % of a polyether triol, 25-35 wt % of a polyether polyol having functionality >3, 5-8 wt % of a polyether diol, based on the total weight of polyether polyol in Component B; or
   (3) 46-83 wt % of a poly(propylene oxide) triol, 19-46 wt % of a poly(propylene oxide) polyol having functionality >3, 4-15 wt % of a poly(propylene oxide) diol, based on the total weight of polyether polyol in Component B; or
   (4) 55-65 wt % of a poly(propylene oxide) triol, 25-35 wt % of a poly(propylene oxide) polyol having functionality >3, 5-8 wt % of a poly(propylene oxide) diol, based on the total weight of polyether polyol in Component B.
43. Any one preceding embodiment, wherein Component B comprises a diol of molecular weight <200 Da, more preferably <150 Da.
44. Any one preceding embodiment, wherein Component B comprises a diol selected from propylene glycol, butane diol, and mixtures of these.
45. Any one preceding embodiment, wherein Component B comprises butane diol (e.g. 1,4-butane diol) being particularly preferred.
46. Any one preceding embodiment, wherein Component B comprises a diol of molecular weight <200 Da at 5 to 12 wt %, more preferably 6-10 wt %, particularly preferably 8-9 wt %, based on the total weight of Component B.
47. Any one preceding embodiment, wherein Component B comprises butane diol (e.g. 1,4-butane diol) at 5 to 12 wt %, more preferably 6-10 wt %, particularly preferably 8-9 wt %, based on the total weight of Component B.
48. Any one preceding embodiment, wherein the catalyst is selected from Lewis bases and Lewis acids.
49. Any one preceding embodiment, wherein the catalyst comprises a catalyst selected from diazabicyclo[2.2.2]octane, tris-2,4,6-((dimethylamino)methyl)phenol, DMDEE (2,2′-Dimorpholinodiethylether), imidazoles, (such as 4-methylimidazole), triethanolamine, polyethyleneimine, and mixtures of these.
50. Any one preceding embodiment, wherein the catalyst comprises diazabicyclo[2.2.2]octane.
51. Any one preceding embodiment, wherein the catalyst comprises an organotin compound.
52. Any one preceding embodiment, wherein the catalyst comprises an organotin compound selected from dioctyltindineodecanoate, dibutyltin di(acetate), di-n-octyltin bis(isooctyl mercaptoacetate), and mixtures of these.
53. Any one preceding embodiment, wherein the catalyst comprises dibutyltin di(acetate).
54. Any one preceding embodiment, wherein the catalyst comprises diazabicyclo[2.2.2]octane and dibutyltin di(acetate).
55. Any one preceding embodiment, wherein the catalyst used at 0.05-0.5 wt %, more preferably 0.1-0.3 wt %, particularly preferably 0.2 wt %, based on the total weight of Component B.
56. Any one preceding embodiment, wherein the catalyst is a mixture of diazabicyclo[2.2.2]octane and dibutyltin di(acetate), used at 0.05-0.5 wt %, more preferably 0.1-0.3 wt %, particularly preferably 0.2 wt %, based on the total weight of Component B.
57. Any one preceding embodiment wherein the aluminium hydroxide concentration in the adhesive mixture resulting from mixing Components A and B (preferably in a 1:1 volumetric ratio) is 20-35 wt %, more preferably at 22-26 wt %, based on the total weight of the mixture.
58. Any one preceding embodiment, wherein the aluminium hydroxide is present in Component A at 20-35 wt %, more preferably at 22-26 wt %, based on the total weight of Component A.
59. Any one preceding embodiment, wherein the aluminium hydroxide is present in Component B at 20-35 wt %, more preferably at 22-26 wt %, based on the total weight of Component B.
60. Any one preceding embodiment, wherein the aluminium hydroxide is present in both Component A and Component B.
61. Any one preceding embodiment, wherein the aluminium hydroxide is present in both Component A and Component B at 20-35 wt %, more preferably at 22-26 wt %, based on the total weight of the respective Component.
62. Any one preceding embodiment, wherein the aluminium hydroxide has a D₅₀ of less than 3 microns, more preferably about 1 micron.
63. Any one preceding embodiment, wherein the adhesive mixture resulting from mixing Components A and B (preferably in a 1:1 volumetric ratio) comprises aluminium hydroxide having a D₅₀ of less than 3 microns, more preferably about 1 micron, at 20-35 wt %, more preferably at 22-26 wt %, based on the total weight of the mixture.
64. Any one preceding embodiment, wherein Component A comprises aluminium hydroxide having a D₅₀ of less than 3 microns, more preferably about 1 micron, at 20-35 wt %, more preferably at 22-26 wt %, based on the total weight of Component A.
65. Any one preceding embodiment, wherein Component B comprises aluminium hydroxide having a D₅₀ of less than 3 microns, more preferably about 1 micron, at 20-35 wt %, more preferably at 22-26 wt %, based on the total weight of Component B.
66. Any one preceding embodiment, wherein both Component A and Component B comprise aluminium hydroxide having a D₅₀ of less than 3 microns, more preferably about 1 micron, at 20-35 wt %, more preferably at 22-26 wt %, based on the total weight of the respective Component.
67. Any one preceding embodiment, wherein the melamine polyphosphate concentration in the adhesive mixture resulting from mixing Components A and B (preferably in a 1:1 volumetric ratio) is 7-15 wt %, more preferably 8-12 wt %, particularly preferably 9-11 wt %, based on the total weight of the mixture.
68. Any one preceding embodiment, wherein melamine polyphosphate is present in Component A at 7-15 wt %, more preferably at 8-12 wt %, based on the total weight of Component A.
69. Any one preceding embodiment, wherein melamine polyphosphate is present in Component B at 7-15 wt %, more preferably at 8-12 wt %, based on the total weight of Component B.
70. Any one preceding embodiment, wherein melamine polyphosphate is present in both Component A and Component B.
71. Any one preceding embodiment, wherein melamine polyphosphate is present in both Component A and Component B at 7-15 wt %, more preferably at 8-12 wt %, based on the total weight of the respective Component.
72. Any one preceding embodiment, wherein the cured adhesive composition resulting from mixing Components A and B preferably has a lap shear strength, on aluminium substrates, after curing and resting for 7 days at 23° C., 50% relative humidity, of 8 MPa or greater, more preferably 9 MPa or greater, particularly preferably 10 MPa or greater, when measured according to the method given in the Examples.
73. Any one preceding embodiment, wherein the cured adhesive composition resulting from mixing Components A and B preferably has a lap shear strength, on aluminium substrates, after curing and resting for 7 days at 23° C., 50% relative humidity, followed by 7 days of Cataplasma treatment of 6 MPa or greater, more preferably 9 MPa or greater, particularly preferably 10 MPA or greater, when measured according to the method given in the Examples.
74. Any one preceding embodiment, wherein the cured adhesive composition resulting from mixing Components A and B preferably has a lap shear strength, on aluminium substrates, after curing and resting for 7 days at 23° C., 50% relative humidity, followed by 168 hours at 85° C. and 85% relative humidity of 8 MPa or greater, more preferably 10 MPa or greater, particularly preferably 11 MPA or greater, when measured according to the method given in the Examples.
75. Any one preceding embodiment, wherein the cured adhesive composition resulting from mixing Components A and B preferably has a lap shear strength, on aluminium substrates, after curing and resting for 7 days at 23° C., 50% relative humidity, followed by 1,000 hours at 85° C. and 85% relative humidity of 8 MPa or greater, more preferably 10 MPa or greater, particularly preferably 11 MPA or greater, when measured according to the method given in the Examples.
76. Any one preceding embodiment, wherein the cured adhesive composition resulting from mixing Components A and B preferably has a UL94 rating of V0, after curing for 7 days at 23° C. and 50% relative humidity.
77. Any one preceding embodiment, wherein the cured adhesive composition resulting from mixing Components A and B (7 days at 23° C. and 50% relative humidity) has a lap shear strength, on aluminium substrates, after curing and resting for 7 days at 23° C., 50% relative humidity, of 8 MPa or greater, more preferably 9 MPa or greater, particularly preferably 10 MPa or greater, when measured according to the method given in the Examples, and a UL94 rating of V0, after curing for 7 days at 23° C. and 50% relative humidity.
78. Any one preceding embodiment, wherein the cured adhesive (7 days at 23° C. and 50% relative humidity) has a lap shear strength, on aluminium substrates, after 7 days of Cataplasma treatment of 6 MPa or greater, more preferably 9 MPa or greater, particularly preferably 10 MPA or greater, when measured according to the method given in the Examples, and a UL94 rating of V0, after curing for 7 days at 23° C. and 50% relative humidity.
79. Any one preceding embodiment, wherein the cured adhesive (7 days at 23° C. and 50% relative humidity) has a lap shear strength, on aluminium substrates, after 168 hours at 85° C. and 85% relative humidity, of 8 MPa or greater, more preferably 10 MPa or greater, particularly preferably 11 MPA or greater, when measured according to the method given in the Examples, and a UL94 rating of V0, after curing for 7 days at 23° C. and 50% relative humidity.
80. Any one preceding embodiment, wherein the cured adhesive composition resulting from mixing Components A and B (7 days at 23° C. and 50% relative humidity) has a lap shear strength, on aluminium substrates, after 1,000 hours at 85° C. and 85% relative humidity of 8 MPa or greater, more preferably 10 MPa or greater, particularly preferably 11 MPA or greater, when measured according to the method given in the Examples, and a UL94 rating of V0, after curing for 7 days at 23° C. and 50% relative humidity.

### Examples

TABLE 1
Ingredients

| Trademark or | |
|---|---|
| abbreviation | Chemistry |
| POLYISO 1 | Polymeric MDI that contains MDI. |
| | Isocyanate equivalent weight: 134 g/mol |
| | % NCO: 31.4% (by weight) |
| | Average molecular weight 340 Da |
| | Nominal functionality: 2.7 |
| WANNATE | Polycarbodiimide-modified MDI |
| 1631 | |
| POLYOL 1 | a polyether polyol based on propylene glycol with |
| | ethylene oxide capping, having a molecular weight of |
| | approximately 2,000 Da, a functionality of 2 |
| TEP | Triethyl phosphate |
| MPP | Melamine polyphosphate |
| APP | Ammonium polyphosphate |
| Dynasilane | Bis(trimethoxysilylpropyl)amine |
| 1124 | |
| S7100 | Carbon black |
| ATH-20 | Aluminium trihydroxide with D₅₀ around 20 micron. |
| ATH-1 | Aluminium trihydroxide with D₅₀ around 1 micron |
| SK7800 | Talc |
| TS720 | Amorphous silica |
| Dynasilan | [3-(2,3-epoxypropoxy)propyl]trimethoxysilane |
| Glymol | |
| Dynasilan | Bis(trimethoxysilylpropyl)amine |
| 1124 | |
| Dynasilan | N,N,N-tris(3-trimethoxysilylpropyl) triisocyanurate |
| 7161 | |
| Glycerine | Glycerine |
| 1,4-BDO | 1,4-butane diol |
| Ethylene | Ethylene glycol |
| glycol | |
| Voranol | A high reactivity capped polyether triol with high |
| 4701 | molecular weight and high primary hydroxyl content. |
| | Average equivalent weight: 1652.4 g/eq |
| | Average OH number: 33 mg KOH/g |
| | Molecular weight: 4957 g/mol |
| T-403 | polyetheramine characterized by repeating oxypropylene |
| | units in the backbone. As shown by the structure, |
| | JEFFAMINE T-403 is a trifunctional primary amine |
| | having an average molecular weight of approximately |
| | 440. Its amine groups are located on secondary carbon |
| | atoms at the ends of aliphatic polyether chains. |
| | 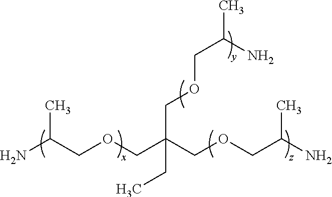 |
| | (x + y + z) = 5-6 |
| Voranol | sorbitol-initiated polyoxypropylene polyether polyol, |
| RN482 | having a hydroxyl number of 482, a nominal |
| | functionality of 6, and an equivalent weight of 117 |
| TP440 | a tri-functional polyol formed by adding propylene |
| | oxide to a trimethylolpropane nucleus |
| | Hydroxyl number 383-413 mg KOH/g |
| | Nominal functionality: 3 |
| | Nominal molecular weight: 400 Da |
| DABCO | 33% diazabicyclo[2.2.2]octane in 67% dipropylene |
| 33-LV | glycol. |
| DABCO DC-2 | Mixture of Dibutyltin di(acetate) and 1,4- |
| | Diazabicyclooctane |
| UL-29 | Di-n-octyltin bis(isooctyl mercaptoacetate) |
| Purmol 4st | Molecular sieve |

### Manufacture of Part a (Isocyanate Component)

MIDI, polyether polyol and aminosilane (Dynasilan 1124) in the amounts listed in Table 2, were first charged into a planetary mixer and mixed at room temperature for 2 hours at mixing speed between 300-1,000 rpm, and then the fillers ATH, MPP, talc, carbon black and amorphous silica were loaded into the mixture. The fillers were pre-dried in an oven at temperatures from 100-200° C. until the moisture level was below 1,000 ppm. The fillers were mixed into the mixture at a mixing speed of 1,000-2,000 rpm for 30-60 minutes. The mixture was then loaded into the cartridge for storage.

### Manufacture of Part B (Polyol Component)

The polyols, silane (Dynasilan) and catalyst in amounts indicated in Table 2 were mixed at 500-1,000 rpm for 5-15 min., and then the fillers ATH, MPP, talc, amorphous silica and molecular sieve were loaded into the mixture. The fillers were pre-dried in an oven at temperatures from 100-200° C. until the moisture level was below 1,000 ppm. The fillers were mixed into the mixture at a mixing speed of 1,000-2,000 rpm for 30-60 minutes. The mixture was then loaded into the cartridge for storage.

### Use of Adhesive

Parts A and B were mixed in a 1:1 volumetric ratio using a static mixer, and can be dispensed manually or robotically onto the substrates.

### Methods

### Flammability

Samples of adhesive were produced by mixing Part A and B in a 1:1 volumetric ratio, and allowing the mixture to cure at 23° C. for 7 days at 50% relative humidity. Flammability of the samples was measured according to UL94 flame tests. Samples were assigned a V0 rating if burning stopped within 10 seconds on a vertical specimen; drips of particles allowed as long as they are not inflamed. The results are reported in Table 2.

### Lap Shear Testing

Lap shear strength was measured according to DIN EN1465, on aluminium alloy 3003. Aluminium substrates (from Novelis, AA6061 T6 1.92 mm MF noPT no lub, 140×25 mm, 1.9 mm thick) were used. The substrates were cleaned with isopropanol before use. The adhesive was produced by mixing Parts A and B in a 1:1 volumetric ratio and applied on one substrate, before the second substrate was joined within 5 minutes. The thickness was adjusted to 1.0 mm, the overlap area was 25 mm×25 mm. The material was cured and rested for 7 days at 23° C., 50% relative humidity before the lap shear tests were performed. The lap shear samples were then mounted in a tensiometer and the lap shear tests were performed, using a pull speed of 10 mm/min. The force deflection curve was monitored and the strength at break was reported as lap shear strength.

Lap shear tests were performed immediately after curing, as well as after 7 days cataplasm exposure (Cataplasma conditions are 7 d @70° C., 100% relative humidity, followed by thermal shock at −30° C. for 24 hours), after 168 hours at 85° C. and 85% relative humidity, and after 1,000 hours at 85° C. and 85% relative humidity. The results are reported in Table 2.

TABLE 2
Composition of Inventive Examples (IE) and Comparative
Examples (CE) in wt %, based on the total weight of the respective Component

| Ingredient | IE1 | JE2 | JE3 | JE4 | CE5 | CE6 | CE7 | CE8 | CE9 |
|---|---|---|---|---|---|---|---|---|---|
| A Component | | | | | | | | | |
| POLYISO 1 | 50 | 50 | 50 | 40 | 50 | 50 | 50 | 50 | 49 |
| WANNATE 1631 | — | — | — | 10 | — | — | — | — | — |
| POLYOL 1 | 11.9 | 11.9 | 11.9 | 11.9 | 18.9 | 18.9 | 14 | 12 | 25 |
| TEP | — | — | — | — | — | — | 10 | — | — |
| MPP | 10 | 10 | 10 | 10 | — | — | — | — | — |
| APP | — | — | — | — | — | — | — | 10 | — |
| Dynasilan 1124 | 2 | 2 | 2 | 2 | — | — | — | 2 | — |
| S7100 | 0.1 | 0.1 | 0.1 | 0.1 | — | — | — | — | 0.1 |
| ATH-20 | — | — | — | — | — | — | 25 | 25 | — |
| ATH-1 | 24.5 | 25 | 24.5 | 24.5 | — | — | — | — | — |
| SK7800 | — | — | — | — | 30.1 | 30.1 | — | — | 25 |
| TS720 | 1.5 | 1 | 1.5 | 1.5 | 1 | 1 | 2 | 1 | 0.9 |
| B Component | | | | | | | | | |
| Dynasilan Glymol | — | — | — | — | — | — | — | — | 1 |
| Dynasilan 1124 | — | — | — | — | 2 | — | — | — | — |
| Dynasilan 7161 | — | — | — | — | — | 2 | 2 | — | — |
| POLYOL 1 | 4.1 | 4.2 | 4.1 | 4.1 | 5.2 | 5.2 | 2 | 4.2 | — |
| 1,4-BDO | 8.9 | 8.6 | 8.9 | 8.6 | 9.5 | 9.5 | 9 | 8.2 | — |
| Ethylene glycol | — | — | — | — | — | — | — | — | 5.8 |
| Voranol 4701 | 33 | 32.85 | 33 | 33.3 | 43 | 43 | 32.9 | 32.5 | 48 |
| T-403 | — | — | — | — | — | — | — | — | 3 |
| Voranol 482 | 16.8 | 18 | 16.8 | 16.8 | 18.1 | 18.1 | 18 | 19 | 3.2 |
| TP440 | — | — | — | — | — | — | — | — | 9.9 |
| DABCO 33-LV | 0.15 | 0.3 | 0.15 | 0.15 | 0.02 | 0.02 | 0.05 | 0.05 | 0.05 |
| DABCO DC-2 | 0.05 | 0.05 | 0.05 | 0.05 | — | — | — | — | — |
| UE-29 | — | — | — | — | 0.02 | 0.02 | 0.05 | 0.05 | 0.05 |
| SK7800 | — | — | — | — | 21.16 | 21.16 | — | — | 28 |
| ATH-20 | — | — | — | — | — | — | 25 | 25 | — |
| ATH-1 | 24.5 | 25 | 24.5 | 24.5 | — | — | — | — | — |
| TEP | — | — | — | — | — | — | 10 | — | — |
| MPP | 10 | 10 | 10 | 10 | — | — | — | — | — |
| APP | — | — | — | — | — | — | — | 10 | — |
| Punnol 4st | 1 | — | 1 | 1 | — | — | — | — | — |
| TS720 | 1.5 | 1 | 1.5 | 1.5 | 1 | 1 | 2 | 1 | 1 |
| Data | | | | | | | | | |
| UL94 flame test | V₀ | V₀ | V₀ | V₀ | No rating¹ | No rating¹ | V₀ | V₀ | No rating¹ |
| Lap shear strength at 23° C., | 12.5 | 11 | 11.1 | 11.6 | 9.1 | 10.7 | 5.6 | 8.8 | 6.8 |
| Aluminium alloy 3003 (MPa) | | | | | | | | | |
| Lap shear strength at 23° C., | — | 11 | 12.2 | — | 3.1 | 3.5 | — | — | — |
| Aluminium alloy 3003 after 7 d | | | | | | | | | |
| Cataplasma (MPa) | | | | | | | | | |
| Lap shear strength at 23° C., | — | 13.5 | 13.9 | — | 4.3 | — | — | 1.3 | — |
| Aluminium alloy 3003 after 168 h | | | | | | | | | |
| 85° C. 85% RH (MPa) | | | | | | | | | |
| Lap shear strength at 23° C., | — | — | 12.1 | — | 3.8 | — | — | — | — |
| Aluminium alloy 3003 after 1000 h | | | | | | | | | |
| 85° C. 85% RH (MPa) | | | | | | | | | |

¹“No rating” means the sample burned outside the rating scale of the method.

Inventive Examples 1-4 all show a UL94 rating of V0, as well as excellent lap shear strength immediately after cure (≥11 MPa). Comparative Examples 5, 6 and 9 had UL94 ratings that were unacceptable, and also showed lower lap shear strengths immediately after curing (<11 MPa). Comparative Examples 7 and 8 had ratings of V0, however, their lap shear strengths immediately after curing were significantly lower (<9 MPa).

Inventive Examples 2 and 3 show excellent retention of lap shear strength after 7 days Cataplasma treatment as well as after 168 hours at 85° C. and 85% relative humidity. In contrast, Comparative Examples 5 an 6 show unacceptable drops in lap shear strength after 7 days Cataplasma treatment, and Comparative Examples 5 and 8 show unacceptable drops in lap shear strength after 168 hours at 85° C. and 85% relative humidity.

1. A two-component thermally conductive polyurethane adhesive formulation comprising:
(A) a first part, comprising: (a1) a polyurethane prepolymer made from at least one polyol, at least one polyisocyanate and an aminosilane, wherein the prepolymer is partially terminated with silane moieties and has reactive NCO moieties; and
(B) a second part, comprising: (b1) one or more polyether polyols; and (b2) one or more catalysts capable of promoting the reaction of the NCO moieties of (a1) with (b1);
wherein at least one of Part A and Part B comprise aluminum hydroxide having a D₅₀ of less than 5 microns, and melamine polyphosphate, such that when Part A and Part B are mixed together to form the adhesive formulation, the aluminum hydroxide concentration is at least 20 wt. %, and the melamine polyphosphate concentration is at least 7 wt. %, all based on the total weight of the adhesive formulation.

2-80. (canceled)

81. The adhesive formulation of claim 1, wherein the polyisocyanate used to make the prepolymer is aromatic.

82. The adhesive formulation of claim 81, wherein the polyisocyanate used to make the prepolymer is selected from methylene diphenyl diisocyanate (MDI), polycarbodiimide-modified MDI, toluene diisocyanate (TDI), p-phenylene diisocyanate (PPDI), naphthalene diisocyanate (NDI), and mixtures of these.

83. The adhesive formulation of claim 1, wherein the polyol used to make the prepolymer in component A is a polyether polyol.

84. The adhesive formulation of claim 83, wherein the polyol used to make the prepolymer in component A comprises polyols selected from poly(alkylene oxide)diols, wherein the alkylene group is C₂-C₆.

85. The adhesive formulation of claim 1, wherein the aminosilane in Component A is preferably of general Formula I or Formula II: 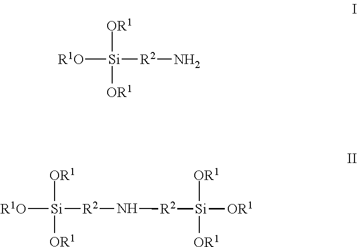
where R¹ is independently selected from C₁-C₆ alkyl, and R² is independently selected from C₂-C₆ alkylene.

86. The adhesive formulation of claim 1, wherein the prepolymer in component A is made using: wherein the prepolymer in Component A is made using: a) MDI and/or polycarbodiimide-modified MDI, or a mixture of MDI and polycarbodiimide-modified MDI at 35-65 wt. %, based on the total weight of component A; b) a polyether polyol based on propylene glycol having an OH value (mg KOH/g) of 109-115 at 5 to 20 wt. %, based on the total weight of component A; and c) aminosilane of general Formula II, wherein R¹ is C₁-C₂ alkyl, and R₂ is C₂-C₄ alkylene at 0.5-4 wt. %, based on the total weight of component A.

87. The adhesive formulation of claim 1, wherein the polyol used in component B is a polyether polyol.

88. The adhesive formulation of claim 87, wherein the polyol used in component B is selected from poly(alkylene oxide)diols, wherein the alkylene group is C₂-C₆.

89. The adhesive formulation of claim 88, wherein the polyether polyol used in component B is a mixture of polyols having functionalities of 2-6.

90. The adhesive formulation of claim 88, wherein the polyether polyol used in component B comprises 46-83 wt. % of a polyether triol, 19-46 wt. % of a polyether polyol having functionality >3, and 4-15 wt. % of a polyether diol, based on the total weight of polyether polyol in component B.

91. The adhesive formulation of claim 88, wherein component B comprises a diol selected from propylene glycol, butane diol, and mixtures of these.

92. The adhesive formulation of claim 88, wherein component B comprises 1,4-butane diol.

93. The adhesive formulation of claim 88, wherein the catalyst is selected from Lewis bases and Lewis acids.

94. The adhesive formulation of claim 93, wherein the catalyst is used at 0.05 to 0.5 wt. %, based on the total weight of component B.

95. The adhesive formulation of claim 1, wherein the aluminum hydroxide is present in both component A and component B.

96. The adhesive formulation of claim 95, wherein both component A and component B comprise aluminum hydroxide having a D₅₀ of less than 3 microns, at 20-35 wt. %, based on the total weight of the respective components.
